(19) United States
(12) Patent Application Publication
(10) Pub. No.: US 2002/0032577 A1
(43) Pub. Date: Mar. 14, 2002

(54) Computer system for assisting the collection of gadgets and method for assisting the collection of gadgets using a computer system

(76) Inventors: Shinichi Yamamoto, Osaka (JP); Bunji Mizuno, Nara (JP); Toru Fukumoto, Kyoto (JP)

Correspondence Address: RATNER AND PRESTIA, Suite 301, One Westlakes, Berwyn, P.O. Box 980, Valley Forge, PA, 19482-0980, US

(21) Appl. No.: 09/875,062

(22) Filed: Jun. 6, 2001

(30) Foreign Application Priority Data
Jun. 6, 2000 (JP) 2000-168545
May 10, 2001 (JP) 2001-140763

(51) Int. Cl. G06F 17/60

(52) U.S. Cl. 705/1

(57) ABSTRACT

A computer system for assisting collection of a gadget, the computer system including: an acquisition section for acquiring usage information representing how the gadget has been used; a calculation section for calculating, based on the usage information, an estimate of a sum of money to be paid to a client in exchange for the gadget to be collected or a sum of money to be paid by the client as a usage fee for the gadget; and a transmission section for transmitting the calculated estimate to the client.

### BACKGROUND OF THE INVENTION

1. Field of the Invention

The present invention relates to a computer system for assisting the collection of gadgets (e.g., household appliances) and a method for assisting the collection of gadgets using a computer system.

2. Description of the Related Art

Conventionally, some waste products, such as household appliances, are dismantled by local governments, waste disposal businesses, or the like to be recycled as raw materials (which is referred to as “material recycling”). However, a large amount of waste products is still being disposed of in landfill or is simply burnt away. The recent environmental issues have not only a spatial expanse at the global level, but also a temporal expanse (as evidenced by the long periods of influences exerted by such waste materials). As a result, the environmental issues have a deep impact on regular business activities and daily life.

Therefore, the environmental issues must be given the highest precedence. In Japan, various legislations have been implemented, including the so-called household appliance recycling law and the so-called container/package recycling law, with a view to establishing a circulating society. Such legislation is aimed at the promotion of the “3R”s, namely, reduction of waste products, reuse of products and product parts, and recycling of raw materials.

However, as manufacturers are required to implement recycling measures under the household appliance recycling law, some users may be tempted to illegally dump gadgets, rather than pay the money to have their gadgets collected. Such illegal dumping of gadgets is detrimental to the promotion of the aforementioned “3R”s. One motivation behind such illegal dumping is the inadequate morals of the users. However, the most significant factor of all is the lack of communication (or insufficient exchange of information) at the time of gadget collection between users of gadgets and entities which promote reuse.

For example, when a user requests a collector (e.g., a secondhand-goods dealer) to pick up a gadget which is left unused in their household, it should make sense that the user is entitled to some pecuniary compensation in exchange for the gadget to be collected if the gadget still retains some value. However, in order to determine the appropriate sum of such compensation, the gadget must be turned in to the collector, who will then estimate what sort of payment should be made in exchange for the gadget. When such an estimation is complete, the user may not even request the collector to collect the gadget if the user is dissatisfied with the estimated sum. In such cases, the user may have to request another collector for a more satisfactory estimate. Thus, hiring a collector to collect gadgets may involve a complicated procedure, which is one reason why some users hesitate to request a collector to collect their gadgets. In order to overcome this situation, it would be necessary to establish a system in which, at the time of gadget collection, information can be easily sent out to business entities which collect gadgets and information can be easily received from such business entities, thereby facilitating a user's process of requesting a business entity to collect gadgets.

On the other hand, one future implication of the regime in which users are required to pay money at the time of collecting gadgets is that more and more users may shift toward renting gadgets, i.e., obtaining rights to use gadgets (e.g., appliance products), rather than owning gadgets, i.e., possessing gadgets as their property.

If such rental systems become prevalent, an Internet/computing environment would be desirable which facilitates the acquisition, processing, and sending out of information which is necessary for entering or terminating a rental arrangement through the use of the Internet, for example.

### SUMMARY OF THE INVENTION

According to the present invention, there is provided a computer system for assisting collection of a gadget, the computer system comprising: an acquisition section for acquiring usage information representing how the gadget has been used; a calculation section for calculating, based on the usage information, an estimate of a sum of money to be paid to a client in exchange for the gadget to be collected or a sum of money to be paid by the client as a usage fee for the gadget; and a transmission section for transmitting the calculated estimate to the client.

In one embodiment of the invention, the acquisition section acquires the usage information over a network.

In another embodiment of the invention, an address for uniquely identifying the gadget on the network is assigned to the gadget; and the acquisition section acquires the usage information by using the address.

In still another embodiment of the invention, the usage information comprises information representing a cumulative value of an ON-time of the gadget.

In still another embodiment of the invention, the calculation section calculates the estimate based on the usage information and information representing a result of functionality diagnosis of the gadget.

Alternatively, there is provided a computer system for assisting the collection of gadgets, the computer system comprising: an acquisition section for acquiring usage information representing how the gadget has been used; a transmission section for transmitting the acquired usage information to a computer of at least one business entity which is capable of collecting the gadget, and a reception section for receiving an estimate of a sum of money to be paid to a client in exchange for the gadget to be collected, the estimate being transmitted from the computer of at least one of the at least one business entity, wherein the transmission section transmits the received at least one estimate to the client.

In one embodiment of the invention, the reception section receives selection information representing one of the at least one business entity which is selected by the client based on the at least one estimate; and the transmission section transmits an order for collecting the gadget to the computer of the at least one business entity which is represented by the selection information.

In another embodiment of the invention, the transmission section selects one of the at least one business entity which proposes the highest estimate, and transmits information representing the selected business entity to the client.

In another aspect of the present invention, there is provided a method for assisting collection of a gadget by using a computer system, comprising the steps of: (a) acquiring, by means of the computer system, usage information representing how the gadget has been used; (b) based on the usage information, calculating, by means of the computer system, an estimate of a sum of money to be paid to a client in exchange for the gadget to be collected or a sum of money to be paid by the client as a usage fee for the gadget; and (c) presenting, by means of the computer system, the estimate to the client.

In one embodiment of the invention, the gadget comprises a recording section for recording the usage information in a manner which prevents falsification by the client, the method further comprising the steps of: (d) receiving at the computer system an order for collecting the gadget from the client; (e) collecting the gadget from the client; and (f) replacing the recording section of the gadget to be collected with a new recording section.

The inventors envisage that the aforementioned “3R”s can effectively be promoted by a system in which a user of a gadget receives an incentive for requesting a business entity to collect the gadget and in which such requests can be easily transacted, irrespective of whether the user actually owns the gadget or the user has obtained a right to use the gadget through a rental agreement. In other words, the present invention provides assistance in gadget collection so as to enable a smooth transaction of gadget collection. As a result, the illegal dumping of gadgets can be minimized, and the recycling of gadgets, whether as a product, product parts, or raw materials, can be promoted.

Thus, the invention described herein makes possible the advantages of (1) providing a computer system for assisting the collection of gadgets, in which, at the time of gadget collection, information can be easily sent out to business entities which collect gadgets and information can be easily received from such business entities, thereby facilitating a user's process of requesting business entities to collect gadgets; and (2) providing a method for assisting the collection of gadgets using a computer system.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating a system 100 for assisting the collection and reuse of gadgets according to Example 1 of the present invention.

FIG. 2 is a circuit diagram illustrating a recording device 1012, which combines the functions of a usage history information storage section 10 and an ON-time measurement section 12 shown in FIG. 1.

FIG. 3 illustrates a flow of communication between a service center 1 and a household 2 in the case where a user 101 requests a business entity 51 to collect a TV 8.

FIG. 4 illustrates another example of how the communication between the service center 1 and the household 2 may be made.

FIG. 5 is a flowchart illustrating a flow of a process for reusing a gadget which was collected in Step ST6 shown in FIG. 3 or FIG. 4.

FIG. 6 is a block diagram illustrating a structure of a system 600 for assisting the collection and reuse of gadgets according to Example 2 of the present invention.

FIG. 7 is a flowchart showing the flow of a go-between process which is executed by a CPU 623 of a server computer 14 shown in FIG. 6.

FIG. 8 illustrates an example of a web page 701 functioning as a user interface to be used by a user 101 to access a server computer 14 shown in FIG. 6.

### DESCRIPTION OF THE PREFERRED EMBODIMENTS

The present specification employs the following terminology. “Sale” means a transfer of title from one party to another. “Rental” means making a leasing agreement between two parties in consideration of a payment, without causing a transfer of title from one to the other. Each party involved in a “sale” or “rental” may be a natural person or a corporation. Note that a “rental” may occur over a specified period or an indefinite period, and the payment may be made in lump sum or in regular or irregular installments.

### EXAMPLE 1

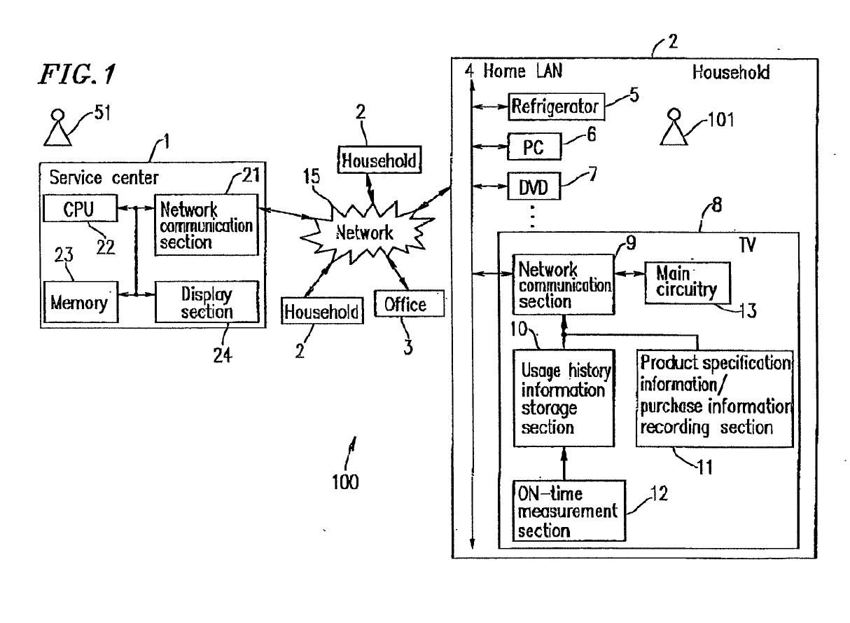

FIG. 1 is a block diagram illustrating a system 100 for assisting the collection and reuse of gadgets according to Example 1 of the present invention.

The system 100 includes a service center 1, households 2, and a network 15 for interconnecting the service center 1 and the households 2. An office 3 may be connected to the network 15. The network 15 may be any arbitrary network (e.g., the Internet). The network 15 may include various LANs (local area networks, including wireless LANs), WANs (wide area networks), telephone networks, wireless telephone networks, and the like.

The service center 1 is operated or managed by a business entity 51. The business entity 51 may be a business entity which can be hired to dismantle gadgets (hereinafter referred to as a “gadget dismantling business”) or a business entity which can be hired to repair gadgets (hereinafter referred to as a “gadget repairing business ”). The business entity 51 can be whole or part of a business entity which sells household appliances. Alternatively, the business entity 51 may be a business entity serving as a liaison between consumers and a gadget dismantling business or a gadget repairing business, such that consumers can place an order to the gadget dismantling business or gadget repairing business through the business entity 51.

In the household 2, gadgets (or household information appliances), such as a refrigerator 5, a personal computer (PC) 6, a DVD (Digital Versatile Disk) recording/reproduction device (DVD) 7, and a television set (TV) 8 may be provided. These gadgets are coupled to one another via a home LAN 4 which is installed in the household 2.

A user 101 of these gadgets lives in the household 2.

The TV 8 includes: a network communication section 9 which communicates with the service center 1 via the network 15; main circuitry 13 for handling the functions of the TV 8; an ON-time measurement section 12 for measuring the ON-time of the TV 8 (i.e., a cumulative amount of time over which the TV 8 has been turned ON); a usage history information storage section 10 for recording the ON-time which has been measured by the ON-time measurement section 12; and a product specification information/purchase information recording section 11 for recording product specification information and purchase information concerning the TV 8.

The product specification information concerning the TV 8 is recorded in the product specification information/purchase information recording section 11 before shipment of the TV 8. The product specification information concerning the TV 8 includes the name of manufacturer, product type, model number, year and month of manufacture, serial number, and the like.

The purchase information concerning the TV 8 is recorded in the product specification information/purchase information recording section 11 when the user purchases the TV 8 (or begins rental of the TV 8). The purchase information concerning the TV 8 includes the year and month in which the user purchased the TV 8 (or began rental of the TV 8).

The ON-time measurement section 12 may be implemented as a timer which is activated concurrently with the activation of the TV 8. Based on a value which is measured by the timer, a cumulative value representing the ON-time of the TV 8 can be calculated. The cumulative value representing the ON-time of the TV 8 may be recorded in the usage history information storage section 10 as usage history information.

Alternatively, the number of times of activation/deactivation of the TV 8 may be recorded in the usage history information storage section 10 as usage history information.

The usage history information which is recorded in the usage history information storage section 10 and the product specification information and purchase information which is recorded in the product specification information/purchase information recording section 11 compose at least a portion of usage information which represents how the TV 8 has been used.

The service center 1 includes: a network communication section 21 which communicates with the gadgets within the household 2 via the network 15; a CPU 22; a memory 23; and a display section 24. The service center 1 may be any computer system, such as a server computer.

Based on the usage information (usage history information, product specification information, and purchase information), the CPU 22 calculates an estimate of a sum of money which is to be paid to the user in exchange for the TV 8 to be collected. An estimate of a sum of money which is to be paid to the user in exchange for the TV 8 to be collected may be calculated in accordance with eq. 1, for example:

estimate of a sum of money which is to be paid to the user C1

=[100−ON-time(hours)/180−(current year and month−year and month of purchase)(years)/0.1]×1000 (yen) eq. 1

If the ON-time of the TV 8 is 1800 (hours), and the (current year and month-year and month of purchase) with respect to the TV 8 is 5 (years), the estimate C1 of a sum of money which is to be paid by the business entity 51 to the user can be calculated to be C1=40000 (yen) in accordance with eq. 1.

If the estimate C1 has a negative value, an absolute value of the estimate C1 may be collected by the business entity 51 from the user 101. Alternatively, the estimate C1 may always be set to zero in the case where the estimate C1 has a negative value, because, even if the main body of the TV 8 does not retain any value, parts of the TV 8 are still recyclable and therefore may be considered as valuable.

Note that eq. 1 is a formula for calculating an estimate of a sum of money which is to be paid to the user in exchange for the TV 8 to be collected in the case where the user owns the TV 8.

In the case where the user has obtained a right to use to the TV 8 through a rental agreement with the business entity 51 rather than owning the TV 8, the user pays a rental fee for a predetermined rental period at the beginning of the rental. Under such circumstances, if the user wishes to terminate the use of the TV 8 before expiration of the predetermined rental period and wishes to have the TV 8 collected (e.g., because the user wishes to rent a different TV 8), then part or whole of the rental fee is paid back in exchange for the collection of the TV 8.

In this case, the estimate of a sum of money which is to be paid to the user in exchange for the TV 8 to be collected may be calculated in accordance with eq. 2, for example:

estimate of a sum of money which is to be paid to the user C2

=[100−ON-time(hours)/180−(current year and month−year and month in which rental was begun)/0.1]×500 (yen) eq. 2

The rental agreement between the business entity 51 and the user 101 may be of such a format that no fee is paid by the user at the time of signing the rental agreement, but that a rental fee (i.e., a “usage fee” for the TV 8) is paid by the user at the time of collecting the TV 8 (i.e., when the actual rental period is finalized). In such cases, the estimate of a sum of money to be paid by the user at the time of collection of the TV 8 may be calculated in accordance with eq. 3, for example:

estimate of a sum of money to be paid by the user C3

32 [ON-time(hours)/180+(current year and month year−and month in which rental was begun)/0.1]×500 (yen) eq. 3

Eq. 1 or 2 may be modified so that the estimate of a sum of money which is to be paid to the user as calculated in accordance with eq. 1 or 2 is decreased in the case where the TV 8 is broken or out of order. Similarly, eq. 3 may be modified so that the estimate of a sum of money to be paid by the user as calculated in accordance with eq. 3 is increased in the case where the TV 8 is broken or out of order. As a result, the user is given an incentive for taking good care of the TV 8 during use, whereby the life of the TV 8 is expected to increase. There is also an advantage on the part of the business entity 51 in that the need to apply costly repair processing in a repair plant prior to re-renting the TV 8 is reduced, thereby resulting in a higher turnover rate of the TV 8.

It is preferable that a different set of calculation formulae corresponding to eqs. 1-3 are provided for each gadget type. Furthermore, it is preferable that a different set of calculation formulae is provided for each model number which falls under the same type. These calculation formulae are previously stored in the memory 23 of the service center 1.

In the illustrated example, the calculation of estimates C1 to C3 in accordance with eqs. 1-3 employs usage history information (ON-time) and purchase information (i.e., year and month of purchase or year and month in which rental was begun) as an indication of history of use of the gadget. However, the usage history information alone, the purchase information (i.e., year and month of purchase or year and month in which rental was begun) alone, or the product specification information (year and month of manufacture) alone may be used for the determination of the estimate. Alternatively, any arbitrary combination of such information may be used.

In this manner, an estimate of a sum of money to be paid to the user in exchange for the gadget to be collected or a sum of money to be paid by the user as a usage fee of the gadget can be calculated in an objective and impartial manner in accordance with eqs. 1-3, based on usage information representing how the gadget has been used.

The memory 23 stores calculation formulae as represented by eqs. 1-3 above, as well as test patterns to be used for a functionality diagnosis of the gadgets.

As used herein, “functionality diagnosis of a gadget” means a diagnosis which is performed to determine whether a gadget is functional or out of order.

The display section 24 is used for the business entity 51 managing the service center 1 (“computer system”) in order to monitor the state of the service center 1. The display section 24 is a CRT display, for example.

The communication between the service center 1 and each of the gadgets provided in the household 2 is realized, for example, by transferring packets of information. A packet includes a header section indicating a destination of transfer and a data section which carries information to be transferred. The header section includes an address which is assigned to each of the gadgets provided in the household 2 and which uniquely identifies each gadget on the network 15. As such an address, for example, an IP address which is assigned to each gadget according to the IPv6 standards can be used. That is, among multiple gadgets connected to the Internet, each gadget is uniquely specified on the Internet by an IP address.

Based on such a packet header section, it is possible to transfer packets from the service center 1 to any particular gadget in the household 2, and transfer packets from any particular gadget in the household 2 to the service center 1.

Similarly, each gadget which is connected to the home LAN 4 in the household 2 includes, in addition to main circuitry for realizing the inherent functions of the gadget, a network communication section 9, a usage history information storage section 10, and a product specification information/purchase information recording section 11.

However, a gadget such as a digital video camera incorporating a CCD does not need to include the ON-time measurement section 12 and the usage history information storage section 10 because a user can conveniently transmit an image taken with such a gadget to the service center 1 for analysis, so that the service center 1 can determine the degree of deterioration of the CCD. Based on the degree of deterioration of the CCD, the ON-time of the gadget can be inferred.

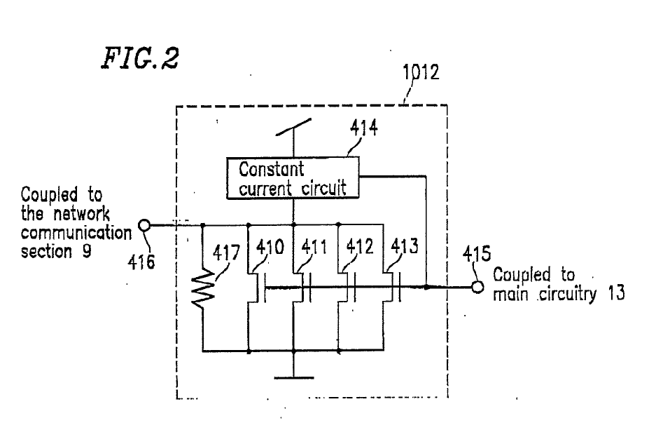

FIG. 2 illustrates a recording device 1012, which combines the functions of the usage history information storage section 10 and the ON-time measurement section 12 shown in FIG. 1. The recording device 1012 is a disposable device which can be replaced as necessary. The recording device 1012 is internalized in the TV 8.

The recording device 1012 includes: a constant current circuit 414; MOS transistors 410 to 413; a node 415 to be coupled to the main circuitry 13 (FIG. 1), a node 416 to be coupled to the network communication section 9; and a resistor 417.

The recording device 1012 receives a control signal from the main circuitry 13 via the node 415. The control signal is input to the constant current circuit 414 and the respective gates of the MOS transistors 410 to 413. Once main power supply to the TV 8 begins (i.e., the TV 8 is turned ON), the control signal shifts to a High level. As a result, the constant current circuit 414 and each of the MOS transistors 410 to 413 are turned ON, so that a current flows between the source and the drain of each of the MOS transistors 410 to 413.

When the main power is no longer supplied to the TV 8 (i.e., the TV 8 is turned OFF), the control signal shifts to a Low level. As a result, the constant current circuit 414 and the MOS transistors 410 to 413 are turned OFF, so that no current flows between the source and the drain of each of the MOS transistors 410 to 413. Thus, a current flows in each of the MOS transistors 410 to 413 only during the ON-time of the TV 8.

Each of the MOS transistors 410 to 413 deteriorates after a predetermined length of ON-time (e.g., a gate oxide film of each MOS transistor undergoes dielectric breakdown), so that it no longer functions as a MOS transistor. For example, the MOS transistors 410 to 413 may be designed so that the gate oxide film will undergo dielectric breakdown when the ON-time of the TV 8 has reached 10000 hours, 5000 hours, 1000 hours, and 500 hours, respectively. Such designing is possible by adjusting the material of the gate oxide film for each of the MOS transistors 410 to 413. For example, when the ON-time of the TV 8 has reached 2000 hours, the gate oxide films of the MOS transistors 412 and 413 will have undergone dielectric breakdown.

The potential of the node 416 can be read by the network communication section 9. The potential which has been read may be transmitted to the service center 1 via the network 15 as information representing a cumulative value of the ON-time of the TV 8.

Once after dielectric breakdown, it is difficult to restore the gate insulation film of a MOS transistor. Therefore, in accordance with the recording device 1012, it is ensured that a user of the TV 8 cannot falsify the information representing a cumulative value of the ON-time of the TV 8.

Thus, the recording device 1012 functions as a recording section for recording information which represents a cumulative value of the ON-time of the TV 8 (information representing how the TV 8 has been used) in such a manner that the user cannot falsify the information.

Although the above-described recording device 1012 is provided in the TV 8, the recording device 1012 may also be provided in any other gadget within the household 2 or the office 3.

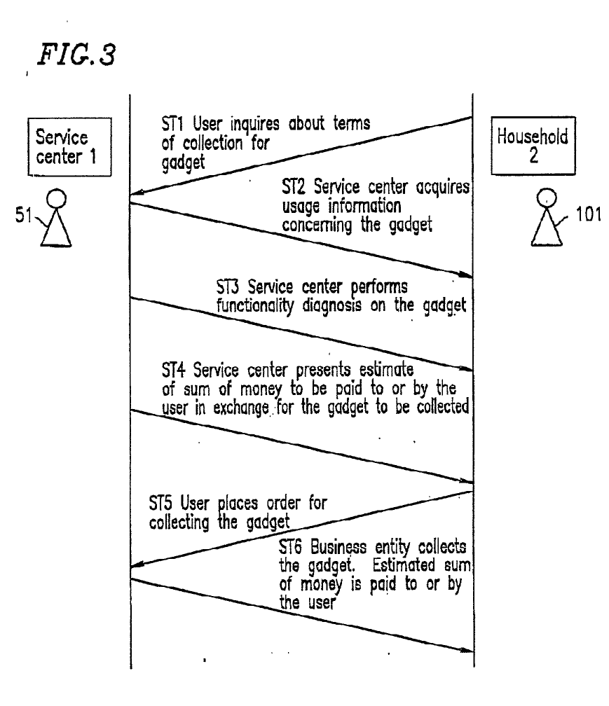

FIG. 3 illustrates a flow of communication between the service center 1 and the household 2 in the case where the user 101 requests the business entity 51 to collect the TV 8. In the example illustrated in FIG. 3, the user inquires to the business entity 51 about the terms of accord under which the TV 8 can be collected (hereinafter referred to as the “terms of collection” for the TV 8), and the user 101 decides on their own discretion whether or not to hire the business entity 51 to collect the TV 8, based on the reply which is given by the business entity 51 in response to the user's inquiry. It will be appreciated that the same principle also applies to gadgets such as the refrigerator 5, the PC 6, and the DVD 7 shown in FIG. 1 or any other gadgets. The same principle also applies to any gadgets (not shown) within the office 3.

Step ST1: The user 101 of the TV 8 inquires to the service center 1 about the terms of collection for the TV 8. The terms of collection for the TV 8 include an estimate of a sum of money to be paid to the user 101 in exchange for the TV 8 or a sum of money to be paid by the user 101 as a usage fee for the TV 8. The terms of collection for the TV 8 may also include a date and a time for the business entity 51 to collect the TV 8.

Such an inquiry may be done over the network 15 by using the PC 6 (FIG. 1), for example. During this inquiry, an address which is assigned to the gadget is transmitted to the service center 1. The TV 8 may be a gadget which is owned by the user 101, or a gadget which is being rented by the user 101 from the business entity 51. In the case where the user 101 wishes to have the currently-rented TV 8 to be collected and rent a new TV, the user 101 may inform the service center 1 of the type, etc., of the TV which the user 101 wishes to newly rent.

Step ST2: After receiving an order for collection from the user 101, the service center 1 acquires (or receives) the usage information concerning the TV 8 which has been accumulated in the usage history information storage section 10 and the product specification information/purchase information recording section 11, and stores the usage information in the memory 23. This acquisition may occur in the following exemplary manner. The service center 1 transmits a packet whose header section includes an IP address which is assigned to the TV 8 over the network 15 via the network communication section 21. Upon receipt of the packet, the gadget (i.e., the TV 8) which is specified by the IP address transmits its own usage information to the service center 1. Then, the service center 1 receives the usage information.

Thus, in Step ST2, the network communication section 21 in the service center 1 functions as an acquisition section for acquiring the usage information which represents how the TV 8 has been used.

Step ST3: The service center 1 performs a functionality diagnosis of the TV 8. This functionality diagnosis may be done over the network 15 by using an address which is assigned to the TV 8, for example. In this case, the service center 1 transmits a predetermined test pattern to the main circuitry 13 of the TV 8 to cause the TV 8 to perform a test operation. The result of the test operation of the TV 8 is transmitted to the service center 1 over the network 15 so as to be examined by the CPU 22. Thus, it is determined whether the main circuitry 13 of the TV 8 is functional or out of order. The result of the determination is stored in the memory 23. In the case where functionality diagnosis cannot be done over the network 15, e.g., when a mechanical disorder of the TV 8 is to be diagnosed, the business entity 51 may inquire from the user 101 as to how the TV 8 is operating.

Thus, it is possible to perform a functionality diagnosis without having to remove the TV 8 from the household 2.

Step ST4: The CPU 22 (“calculation section”) of the service center 1 calculates an estimate of a sum of money which is to be paid to the user 101 in exchange for the TV 8 to be collected, based on the usage information which is stored in the memory 23 and the information representing the result of the functionality diagnosis of the TV 8 which was performed at Step ST3. Such an estimate may be calculated in accordance with eq. 1 or eq. 2, for example. If the user 101 is renting the TV 8, and it has been agreed to pay the rental fee later, the CPU 22 calculates an estimate of a sum of money to be paid by the user 101 as a usage fee for the TV 8 in accordance with eq. 3.

The calculated estimate, which is transmitted to the PC 6 of the user 101 over the network 15, is presented to the user 101. Thus, in Step ST4, the network communication section 21 functions as a transmission section for transmitting the estimate to the computer of the user 101. Concurrently with the transmission of the estimate, a date and a time for the business entity 51 to collect the TV 8 may be transmitted to the user 101.

Step ST5: Based on the terms of collection (i.e., the estimated sum of money) which are presented to the user 101, the user 101 decides whether or not to accept the offer for collection of the TV 8 as proposed by the business entity 51. This decision may be made by taking into consideration the proposed date and time for the business entity 51 to collect the TV 8.

In the case of accepting the offer for collection of the TV 8 as proposed by the business entity 51, the user 101 transmits an order for collecting the TV 8 to the service center 1. The network communication section 21 in the service center 1 receives the order for collecting the gadget, which is transmitted by the user 101 to the service center 1 (“computer system”) upon consideration of the estimate.

In the case of not accepting the offer for collection of the TV 8 as proposed by the business entity 51, the user 101 may inquire to another business entity (not shown) about its proposed terms of collection for the TV 8.

The process of Step ST5 does not need to occur over the network 15. For example, the process of Step ST5 may be omitted, and instead the user 101 may telephone the business entity 51 to place an order for collecting the TV 8.

Step ST6: The business entity 51 collects the TV 8 on the date and time represented by the information which was transmitted in Step ST4. At this time, the business entity 51 may pay the estimated sum of money to the user 101. In other cases, the business entity 51 may receive the estimated sum of money from the user 101 as a usage fee for the TV 8. In the case where the user 101 wishes to begin renting a new TV, the new TV may be brought in when the TV 8 is collected.

Some of the functions of the service center 1 shown in FIG. 1 may be replaced by those of the PC 6. For example, in Step ST2 shown in FIG. 3, the network communication section 21 in the service center 1 functions as an acquisition section for acquiring usage information which represents how the gadget has been used, but this acquisition section function may be implemented by the PC 6. In this case, the PC 6 acquires usage information representing how the gadget (e.g., TV 8) has been used, via the home LAN 4. Then, the PC 6 may transmit the usage information to the service center 1 over the network 15. In this case, the service center 1 does not need to directly (i.e., as opposed to via the PC 6) communicate with any gadgets in the household 2 or the office 3; rather, the service center 1 can communicate with the PC 6. Therefore, it is not imperative that an address for uniquely identifying each gadget on the network 15 be assigned to each gadget. However again, from the perspective of reliability of the usage information which is acquired by the service center 1, it is preferable that the service center 1 directly communicates with each gadget by using such an address to acquire the usage information. As a result, the user 101 is prevented from fraudulently rewriting the usage information which has already been acquired by the PC 6.

In Step ST4 described with reference to FIG. 3 above, the CPU 22 of the service center 1 functions as a calculation section for calculating an estimate of a sum of money to be paid to the user 101 in exchange for the gadget to be collected or a sum of money to be paid by the user 101 as a usage fee for the gadget based on the usage information. However, this calculation section function may be implemented with the PC 6 by, for example, employing the PC 6 to execute a program for calculating an estimate in accordance with any one of eqs. 1-3. Such a program may be downloaded by the user 101 from the service center 1 to the PC 6. Alternatively, a recording medium on which such a program is recorded may be provided from the business entity 51 to the user 101. Thus, in embodiments where the acquisition section function in Step ST2 and the calculation section function in Step ST4 are implemented by the PC 6, the user 101 can know an estimate of a sum of money to be paid to the user 101 in exchange for the gadget to be collected or a sum of money to be paid by the user 101 as a usage fee for the gadget without logging onto the service center 1.

Thus, the service center 1 and the PC 6 may cooperate to function as a computer system for assisting the collection of gadgets.

Moreover, some of the functions of the PC 6 shown in FIG. 1 may be internalized within each of the gadgets 5 to 8. For example, in the case where the TV 8 has an appropriate input device and a display device, and an address (e.g., IP address) is assigned to the TV 8, the inquiry which is made in Step ST1 of the flow of process shown in FIG. 3 may be performed by using such input/display devices, rather than using the PC 6. In this case, the estimate which is calculated in Step ST4 is transmitted to the TV 8, rather than the PC 6, so as to be displayed on a user interface of the TV 8. As such an input device, a ten-key pad may be used, for example; as such a display device, a liquid crystal display screen may be used, for example. Alternatively, any device for realizing the inherent functions of the TV 8 may be utilized as the aforementioned user interface. For example, a remote control for controlling the TV 8 may be used as the aforementioned input device, and the screen of the TV 8 may be utilized as the aforementioned display device. Thus, in embodiments where each gadget in the household 2 and the office 3 has appropriate input/display devices, and an address is assigned to each gadget, the service center 1 can directly communicate with the gadgets in Step ST1 to Step ST5 of the flow of process shown in FIG. 3, without employing the PC 6 (user's computer).

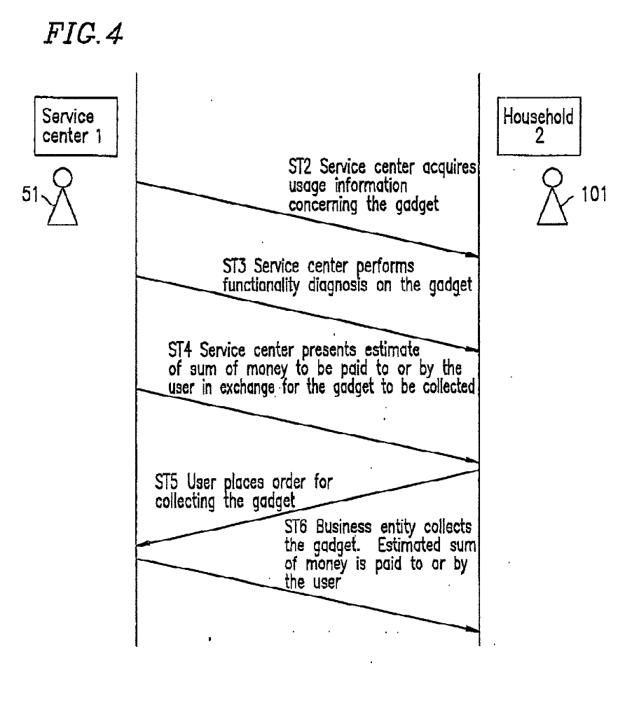

FIG. 4 illustrates another example of how the communication between the service center 1 and the household 2 may be made. In FIG. 4, any steps which are identical with the steps shown in FIG. 3 are denoted by the same reference numerals as those used therein, and the descriptions thereof are omitted. In the example shown in FIG. 4, a communication for collecting a gadget of the user 101 is begun from the business entity 51. In other words, an inquiry from the user 101 as to the terms of collection for the gadget (Step ST1 in FIG. 3) is not made. The mode of gadget collection shown in FIG. 4 can be suitably employed in the case where, for example, the business entity 51 is whole or part of a business entity which sells household appliances, and the business entity 51 desires to sell a new product of the gadget to the user 101. The mode of gadget collection shown in FIG. 4 also provides an advantage for the user 101 in that the user 101 is prompted to switch to a new product, whether via owning or renting, in a timely manner.

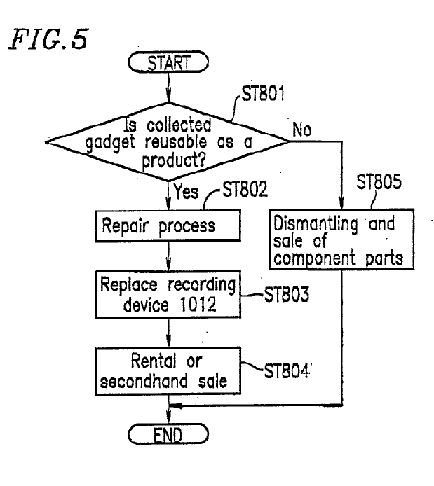

FIG. 5 illustrates a flow of a process for reusing a gadget which was collected in Step ST6 shown in FIG. 3 or FIG. 4. It is assumed that the gadget to be collected includes the recording device 1012 which was described with reference to FIG. 2.

Step ST801: It is determined whether or not the gadget to be collected is reusable as a product. If the result of determination in Step ST801 is “Yes”, the process proceeds to Step ST802. If the result of determination in Step ST801 is “No”, the process proceeds to Step ST805.

Step ST802: The collected gadget is subjected to a repair process. This process may be performed by the business entity 51 itself at a factory, or may be entrusted to a specialized business entity. In this process, for example, any expendable parts may be exchanged, and/or overhauling and cleaning may be performed.

Step ST803: The recording device 1012 is replaced with a new one.

Step ST804: The gadget is subjected to rental or secondhand sale, so that the gadget is reused as a product.

Step ST805: The gadget is dismantled, and component parts thereof are subjected to sale, so that the component parts are reused. The dismantling process may be performed by the business entity 51 itself, or may be entrusted to a specialized business entity.

In the case where it proves impossible to reuse the component parts of the dismantled gadget, the dismantled gadget or the component parts thereof may be recycled as raw materials.

Thus, in accordance with the system 100 for assisting the collection and reuse of gadgets according to Example 1 of the present invention, a user can easily send out information to business entities, and obtain information from business entities, regardless of whether the user owns the gadget or merely has a right to use the gadget through a rental agreement. As a result, the user can conveniently request a business entity to collect gadgets without much trouble. Moreover, the estimation of a sum of money to be paid to the user in exchange for the gadget to be collected or a sum of money to be paid by the user as a usage fee for the gadget (“terms of collection”) can be made on a fair basis in accordance with how the gadget has been used. Thus, the present invention provides assistance in the smooth collection of gadgets.

Moreover, the present invention provides an environment in which the acquisition, processing, and sending out of information which is necessary for entering or terminating a rental agreement can be easily performed.

The service center 1 calculates an estimate of a sum of money to be paid to the user in exchange for the gadget to be collected or a sum of money to be paid by the user as a usage fee for the gadget, based on the usage information concerning the gadget. As a result, users are given an incentive for requesting a business entity to collect their gadgets, and thus taking good care of the gadgets during use. Thus, the gadgets used by users, and component parts thereof, can enjoy improved longevity. As such, users are actively involved in a circulating society through requesting a business entity to collect their gadgets, rather than throwing away the gadgets.

Example 1 illustrates a case in which a user of a gadget acts as a client who makes an inquiry to the service center 1 regarding terms of collection for the gadget. However, not only the user of a gadget but also any other person who wishes to have the gadget collected, e.g., a family member of the user or a colleague of the user, can act as a client to make an inquiry to the service center 1 regarding terms of collection for the gadget. In this case, the communication as shown in FIGS. 3 and 4 occurs between the client and the service center 1.

### EXAMPLE 2

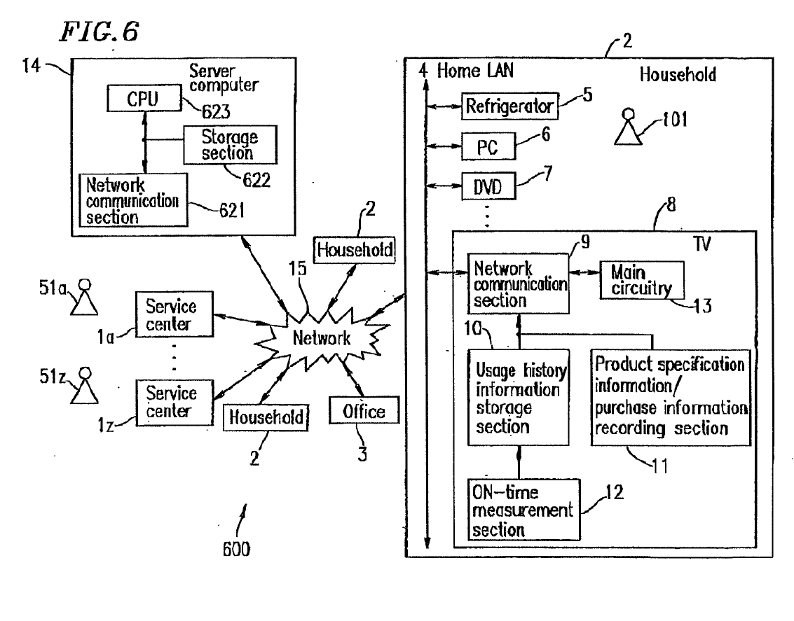

FIG. 6 illustrates a structure of a system 600 for assisting the collection and reuse of gadgets according to Example 2 of the present invention. In FIG. 6, the component elements which also appear in FIG. 1 are denoted by the same reference numerals as those used therein, and the descriptions thereof are omitted.

The system 600 includes a server computer 14, service centers 1a to 1z, households 2, and a network 15 for interconnecting the server computer 14 and the households 2. An office 3 may be connected to the network 15.

Each of the service centers 1a to 1z may be a computer which has a structure similar to that of the service center 1 shown in FIG. 1. The service centers 1a to 1z are managed by business entities 51a to 51z, respectively, each of which is capable of collecting gadgets. Each of the business entities 51a to 51z maybe, for example, a gadget dismantling business or a gadget repairing business. Each of the business entities 51a to 51z may be whole or part of a business entity which sells household appliances.

The server computer 14 (“computer system”) includes: a network communication section 621 used for coupling the server computer 14 to the network 15; a storage section 622; and a CPU 623.

The server computer 14 performs a go-between process between a user 101 and the service centers 1a to 1z. Note that Example 2 of the present invention does not encompass collection of any gadgets that are rented to the user 101 because, if a gadget which is rented to the user 101 were to be collected according to Example 2 of the present invention, there would be no guarantee that the same business entity that rented the gadget to the user 101 will collect the gadget from the user 101. Accordingly, it is assumed that any gadget which is to be collected according to Example 2 of the present invention is a gadget which is owned by the user 101.

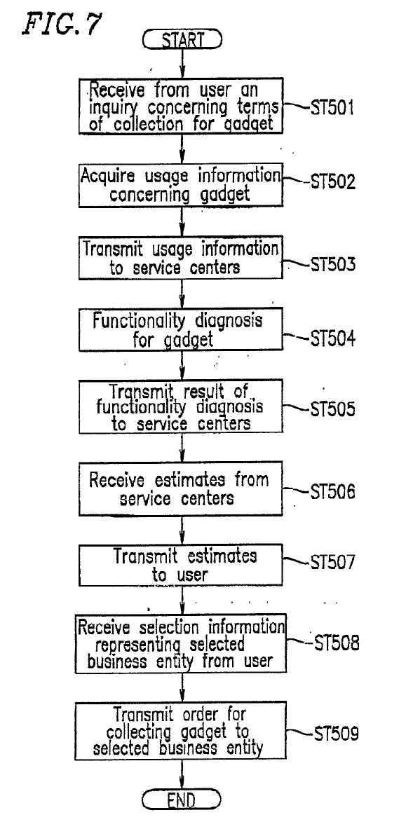

FIG. 7 shows a flow of the go-between process which is executed by the CPU 623 of the server computer 14. Hereinafter, the go-between process will be described with respect to a case where the user 101 requests one of the business entities 51a to 51z to collect the TV 8. It will be appreciated that the same principle also applies to gadgets such as the refrigerator 5, the PC 6, and the DVD 7 shown in FIG. 6 or any other gadgets. The same principle also applies to any gadgets (not shown) within the office 3.

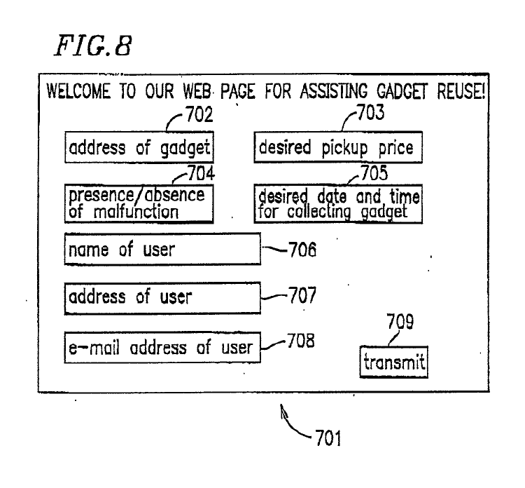

Step ST501: An inquiry concerning terms of collection for the TV 8 is received from the user 101. The user 101 may transmit the inquiry concerning terms of collection via a web page (described later with reference to FIG. 8), for example. Such a web page may be provided by the server computer 14.

The terms of collection for the TV 8 include an estimate of a sum of money to be paid to the user 101 in exchange for the TV 8. The terms of collection for the TV 8 may also include a date and a time for any of the business entities 51a to 51z (respectively managing the service centers 1a to 1z) to collect the TV 8.

Step ST502: The usage information concerning the TV 8 is acquired. This step is performed in the same manner as Step ST2 shown in FIG. 4. In Step ST502, the network communication section 621 in the server computer 14 functions as an acquisition section for acquiring usage information which represents how the TV 8 has been used.

Step ST503: To each of the service centers 1a to 1z (i.e., to each of the computers of the business entities 51a to 51z), the usage information acquired in Step ST502 is transmitted. In Step ST503, the network communication section 621 in the server computer 14 functions as a transmission section for transmitting usage information to the business entities 51a to 51z.

Each of the service centers 1a to 1z calculates an estimate of a sum of money which is to be paid to the user in exchange for the gadget to be collected, based on the usage information concerning the TV 8.

Step ST504: The TV 8 is subjected to a functionality diagnosis. This functionality diagnosis may be performed in the same manner as Step ST3 which was described with reference to FIG. 4. That is, the service center 1 transmits a predetermined test pattern to the main circuitry 13 of the TV 8 to cause the TV 8 to perform a test operation. The result of the test operation of the TV 8 is transmitted to the service center 1 over the network 15 so as to be examined by the CPU 623. Thus, it is determined whether the main circuitry 13 of the TV 8 is functional or out of order.

Step ST505: The result of the functionality diagnosis performed in Step ST504 is transmitted to each of the service centers 1a to 1z. Alternatively, the examination of the result of the test operation by the CPU 623 of the server computer 14 in Step ST504 may be omitted, and the server computer 14 may transmit the unprocessed result of the test operation to each of the service centers 1a to lz in Step ST505. In this case, the result of the test operation is examined in each of the service centers 1a to 1z, and it is determined whether the TV 8 is functional or out of order.

Steps ST504 and ST505 may be omitted. In the case where Steps ST504 and ST505 are performed, each of the service centers 1a to 1z may consider the result of the functionality diagnosis at the time of calculating an estimate of a sum of money which is to be paid to the user in exchange for the TV 8 to be collected.

The calculation of the estimate can be performed in the same manner as the estimate calculation by the service center 1 shown in FIG. 1 as performed in accordance with eq. 1 (Step ST4 in FIG. 3). However, each of the service centers 1a to 1z may calculate an estimate based on its own calculation formula.

Step ST506: An estimate is received from each of the service centers 1a to 1z. In Step ST506, the network communication section 621 functions as a reception section for receiving the estimates of a sum of money which is to be paid to the user in exchange for the gadget to be collected which are transmitted from the service centers 1a to 1z (i.e., the computers of the business entities 51a to 51z).

Step ST507: The estimates calculated by the respective service centers 1a to 1z, which were received in Step ST506, and the names of the respective business entities in charge of the service centers which calculated the estimates are transmitted to the PC 6 of the user 101 (i.e., presented to the user 101). If an estimate is not received from some of the service centers 1a to 1z in Step ST506, at least one received estimate and the name(s) (or any information representing the business entity) of the business entity(s) in charge of the service center(s) which calculated the estimate(s) are transmitted. Based on these estimates, the user 101 selects a business entity to order collection of the gadget. A date and a time for a business entity to collect the gadget may be received in Step ST506, and the date and time may be transmitted to the PC 6 in Step ST507. The user 101 may make the selection of a business entity by giving a higher priority to the estimates or to the date and time of collection. Alternatively, the selection may be made while considering various service plans provided by each business entity (e.g., a service plan under which a discount is given, in exchange for the gadget to be collected, on the selling price of a new product which the business entity hopes the user will buy and use in the place of the gadget to be collected). Usually, the user 101 will select a business entity which offers the highest estimate. Accordingly, in Step ST507, the server computer 14 may select a business entity which proposes the highest estimate among all the business entities 51a to 51z, and transmit information representing the selected business entity (e.g., the name of the business entity) to the PC 6 (“computer”) of the user 101.

Step ST508: Information representing a selected business entity (“selection information”) is received from the user 101.

Step ST509: An order for collecting the gadget is transmitted to the service center (“computer”) of the selected business entity. The business entity which has received the order for collecting the gadget collects the gadget in accordance with the designated date and time, at which time the business entity pays the estimated sum of money to the user 101.

The collected gadget is reused in accordance with the procedure shown in FIG. 5 as in Example 1.

Some of the functions of the server computer 14 associated with the respective steps shown in FIG. 7 may be replaced by those of the PC 6. In that case, the server computer 14 and the PC 6 cooperate to function as a computer system for assisting the collection of gadgets.

The processes of Steps ST508 and ST509 may be omitted. In that case, the user 101 may directly place an order for collecting the gadget to a desired business entity.

The server computer 14 performs a go-between process between the plurality of business entities 51a to 51z and the user 101. As a result, the user 101 can simply access the server computer 14 to select a desired business entity among the plurality of business entities 51a to 51z, without contacting each individual business entity 51a to 51z. Any user interface maybe used by the user 101 to access the server computer 14. However, from the perspective of access facility, a web page on the World Wide Web can suitably be used as such a user interface.

FIG. 8 illustrates an example of a web page 701 functioning as a user interface to be used by the user 101 to access the server computer 14.

The web page 701 may be described in any arbitrary page description language (e.g., HTML language). A file which describes the web page 701 is stored in the storage section 622 in the server computer 14. This file has a URL address which uniquely identifies a position on the network 15 at which this file is stored. Once the user 101 inputs this URL address to any web page browsing software which is being executed on the PC 6, the web page 701 is displayed on the PC 6.

The web page 701 includes regions 702 to 708 and a transmission button 709. After inputting necessary information in the regions 702 to 708, the user 101 may select the transmission button 709 (with a mouse click, for example) to transmit an inquiry about terms of collection for the gadget to the server computer 14. As a result, the go-between process shown in FIG. 7 begins.

In the region 702, an IP address which is assigned to a gadget which the user 101 wishes collection of is input as an IP address identifying that gadget.

In the region 703, a desired sum of money (“pickup price”) to be paid to the user 101 in exchange for the gadget to be collected may be input. The inputting of a desired sum of money may be omitted. In the case where a desired sum of money is input, only the names of those business entities which proposed estimates that are higher than the desired sum of money may be transmitted together with the estimates proposed by such business entities to the PC 6 in Step ST507 of FIG. 7.

In the region 704, the presence or absence of malfunctioning of the gadget may optionally be input. The inputting of this information may be omitted because the presence or absence of malfunctioning of the gadget can also be known based on the determination which is made in Step ST504 shown in FIG. 7. On the other hand, if the presence or absence of malfunctioning of the gadget is input in the region 704, Step ST504 in FIG. 7 may be omitted.

In the region 705, a date and a time (“desired date and time”) indicating when the user 101 wishes collection of the gadget may be input. The inputting of this information may be omitted. If a desired date and time is input, only the names of those business entities which can collect the gadget in accordance with the desired date and time maybe transmitted together with the estimates proposed by such business entities to the PC 6 in Step ST507 of FIG. 7.

In the regions 706 to 708, the name, residence, and e-mail address of the user 101 are input, respectively.

Thus, in accordance with the system for assisting the collection of gadgets according to Example 2 of the present invention, in the case where a user owns a gadget, the user can conveniently request a business entity to collect the gadget without much trouble. Moreover, the estimation of a sum of money to be paid to the user in exchange for the gadget to be collected (“terms of collection”) can be made on a fair basis in accordance with how the gadget has been used. Thus, the present invention provides assistance in the smooth collection of gadgets.

Each of the service centers 1a to 1z calculates an estimate of a sum of money to be paid to the user in exchange for the gadget to be collected, based on the usage information concerning a gadget. As a result, users are given an incentive for requesting a business entity to collect their gadgets, and thus taking good care of the gadgets during use. Thus, the gadgets used by users, and component parts thereof, can enjoy improved longevity. As such, users are actively involved in a circulating society through requesting a business entity to collect their gadgets, rather than throwing away the gadgets.

In accordance with the system for assisting the collection of gadgets according to Example 2 of the present invention, in the case where a plurality of service centers are connected to the network 15, it is possible to allow a plurality of business entities to propose their estimated terms of collection for a gadget, in the fashion of an auction, where the server computer 14 acts as a go-between. As a result, a user can exercise his/her own discretion in selecting a business entity which proposes terms of collection that are satisfactory to the user.

One or more service centers may be connected to the network 15. Preferably, a plurality of service centers are connected to the network 15 so as to allow a user to exercise his/her own discretion in selecting a business entity which proposes terms of collection that are satisfactory to the user.

Example 2 illustrates a case in which a user of a gadget acts as a client who makes an inquiry to the server computer 14 regarding terms of collection for the gadget. However, not only the user of a gadget but also any other person who wishes to have the gadget collected, e.g., a family member of the user or a colleague of the user, can act as a client to make an inquiry to the server computer 14 regarding terms of collection for the gadget. In this case, the go-between process shown in FIG. 7 occurs so as to mediate between the client and a plurality of service centers.

Although Examples 1 and 2 above illustrate household information appliances as gadgets to be collected, any gadget is suitable for collection according to the present invention so long as the usage information concerning that gadget can be acquired by means of a computer system. For example, the gadget to be collected may be an automobile.

According to the present invention, usage information representing how a gadget has been used is received by a computer system, and based on the usage information, an estimate of a sum of money which is to be paid to a client in exchange for the gadget to be collected or a sum of money which is to be paid by the client as a usage fee for the gadget (“terms of collection”) is calculated. As a result, the estimation of terms of collection for the gadget can be made in an objective and impartial manner without having to move the gadget. Thus, assistance in the smooth collection of gadgets is provided, regardless of whether the gadget is owned or rented by the client.

Moreover, according to the present invention, a user is allowed to select a business entity which proposes terms of collection that are satisfactory to the user.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A computer system for assisting collection of a gadget, the computer system comprising:
an acquisition section for acquiring usage information representing how the gadget has been used;
a calculation section for calculating, based on the usage information, an estimate of a sum of money to be paid to a client in exchange for the gadget to be collected or a sum of money to be paid by the client as a usage fee for the gadget; and
a transmission section for transmitting the calculated estimate to the client.

2. A computer system according to claim 1, wherein the acquisition section acquires the usage information over a network.

3. A computer system according to claim 2, wherein:
an address for uniquely identifying the gadget on the network is assigned to the gadget; and
the acquisition section acquires the usage information by using the address.

4. A computer system according to claim 1, wherein the usage information comprises information representing a cumulative value of an ON-time of the gadget.

5. A computer system according to claim 1, wherein the calculation section calculates the estimate based on the usage information and information representing a result of functionality diagnosis of the gadget.

6. A computer system for assisting the collection of gadgets, the computer system comprising:
an acquisition section for acquiring usage information representing how the gadget has been used;
a transmission section for transmitting the acquired usage information to a computer of at least one business entity which is capable of collecting the gadget, and
a reception section for receiving an estimate of a sum of money to be paid to a client in exchange for the gadget to be collected, the estimate being transmitted from the computer of at least one of the at least one business entity,
wherein the transmission section transmits the received at least one estimate to the client.

7. A computer system according to claim 6, wherein:
the reception section receives selection information representing one of the at least one business entity which is selected by the client based on the at least one estimate; and
the transmission section transmits an order for collecting the gadget to the computer of the at least one business entity which is represented by the selection information.

8. A computer system according to claim 6, wherein the transmission section selects one of the at least one business entity which proposes the highest estimate, and transmits information representing the selected business entity to the client.

9. A method for assisting collection of a gadget by using a computer system, comprising the steps of:
(a) acquiring, by means of the computer system, usage information representing how the gadget has been used;
(b) based on the usage information, calculating, by means of the computer system, an estimate of a sum of money to be paid to a client in exchange for the gadget to be collected or a sum of money to be paid by the client as a usage fee for the gadget; and
(c) presenting, by means of the computer system, the estimate to the client.

10. A method according to claim 9, wherein the gadget comprises a recording section for recording the usage information in a manner which prevents falsification by the client, the method further comprising the steps of:
(d) receiving at the computer system an order for collecting the gadget from the client;
(e) collecting the gadget from the client; and
(f) replacing the recording section of the gadget to be collected with a new recording section.
